(19) United States
(12) Patent Application Publication
(10) Pub. No.: US 2026/0111917 A1
(43) Pub. Date: Apr. 23, 2026

(54) SYSTEM

(71) Applicant: SOFTBANK GROUP CORP., Minato-ku (JP)

(72) Inventor: Hiroaki HASUIKE, Minato-ku (JP)

(73) Assignee: SOFTBANK GROUP CORP., Minato-ku (JP)

(21) Appl. No.: 19/357,279

(22) Filed: Oct. 14, 2025

(30) Foreign Application Priority Data
Oct. 17, 2024 (JP) 2024-181681

(51) Int. Cl. G06Q 30/018; G06F 40/279; G06F 40/30; G10L 25/63

(52) U.S. Cl. CPC G06Q 30/0185; G06F 40/279; G06F 40/30; G10L 25/63

(57) ABSTRACT

A system includes a processor that is configured to generate a machine learning model for identifying fraudulent activity based on past scam cases, convert audio data from a communication device into text data, input the converted text data into the machine learning model and evaluate the possibility of fraud, notify the user with a warning if the possibility of fraud is evaluated, and provide the user with specific countermeasures to protect themselves from fraud.

### CROSS-REFERENCE TO RELATED APPLICATION

This application is based on and claims priority under 35 USC 119 from Japanese Patent Application No. 2024-181681 filed on October 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

### SUMMARY

The present disclosure provides a system including a processor,

wherein the processor is configured to generate a machine learning model for identifying fraudulent activity based on past scam cases,

convert audio data from a communication device into text data,

input the converted text data into the machine learning model and evaluate the possibility of fraud,

notify the user with a warning if the possibility of fraud is evaluated, and

provide the user with specific countermeasures to protect themselves from fraud.

“Machine learning model” means a computational model trained on historical data to automatically recognize patterns or features associated with specific types of events or behaviors, such as fraudulent activities.

“Fraudulent activity” means actions or behaviors intended to deceive, trick, or obtain unauthorized benefit from another party, particularly in the context of phone scams.

“Past scam cases” means previously recorded incidents or occurrences of phone scams or fraudulent activity, which are used as reference data for training and improving the system.

“Audio data” means electronic representations of sound, such as voice or speech transmitted via a communication device during a phone call.

“Text data” means the output of transcribed or converted audio data, represented in a written or typed format suitable for text-based analysis.

“Communication device” means any apparatus, such as a smartphone or telephone, which allows users to transmit and receive audio data.

“Natural language processing technology” means computational methods and algorithms used to analyze, interpret, and understand human language as it is spoken or written.

“Warning” means a notification or alert provided to the user indicating a potential risk or threat has been detected, specifically regarding the possibility of fraudulent activity.

“Countermeasures” means specific actions, recommendations, or instructions provided to the user to help protect themselves from fraud or mitigate the effects of a potential scam.

“Processor” means an electronic circuit or component capable of executing instructions, performing computations, and controlling the actions of the system according to programmed logic.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

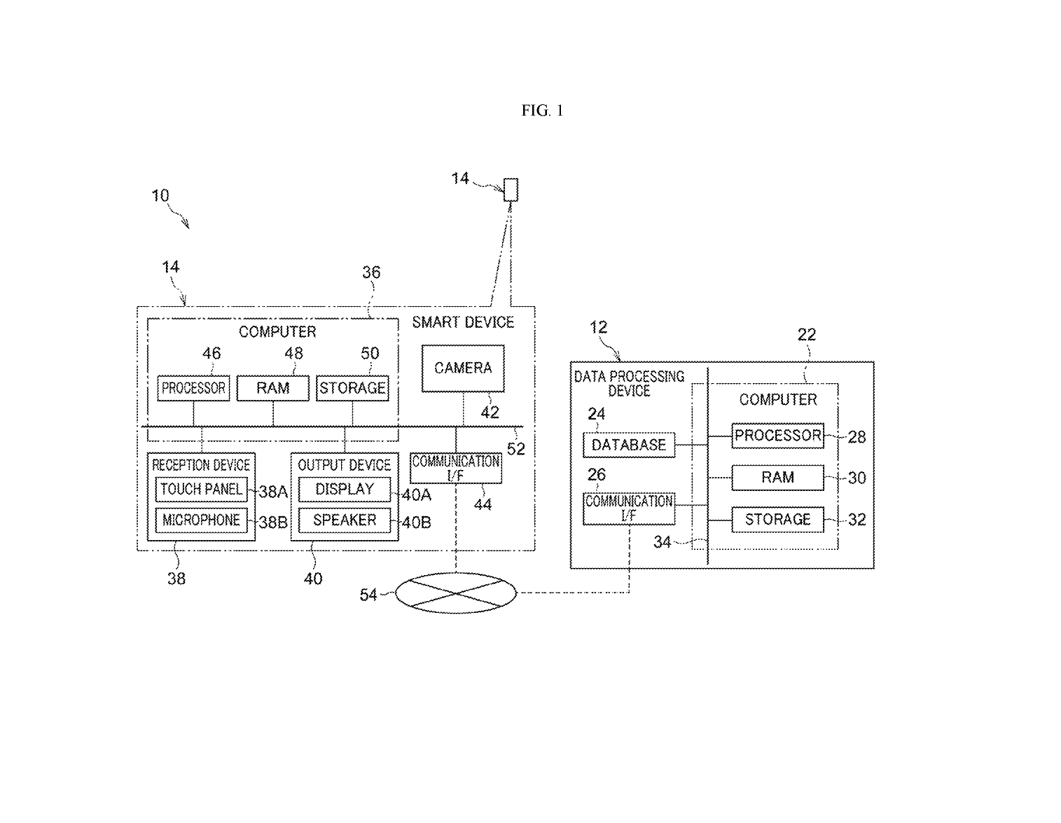

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

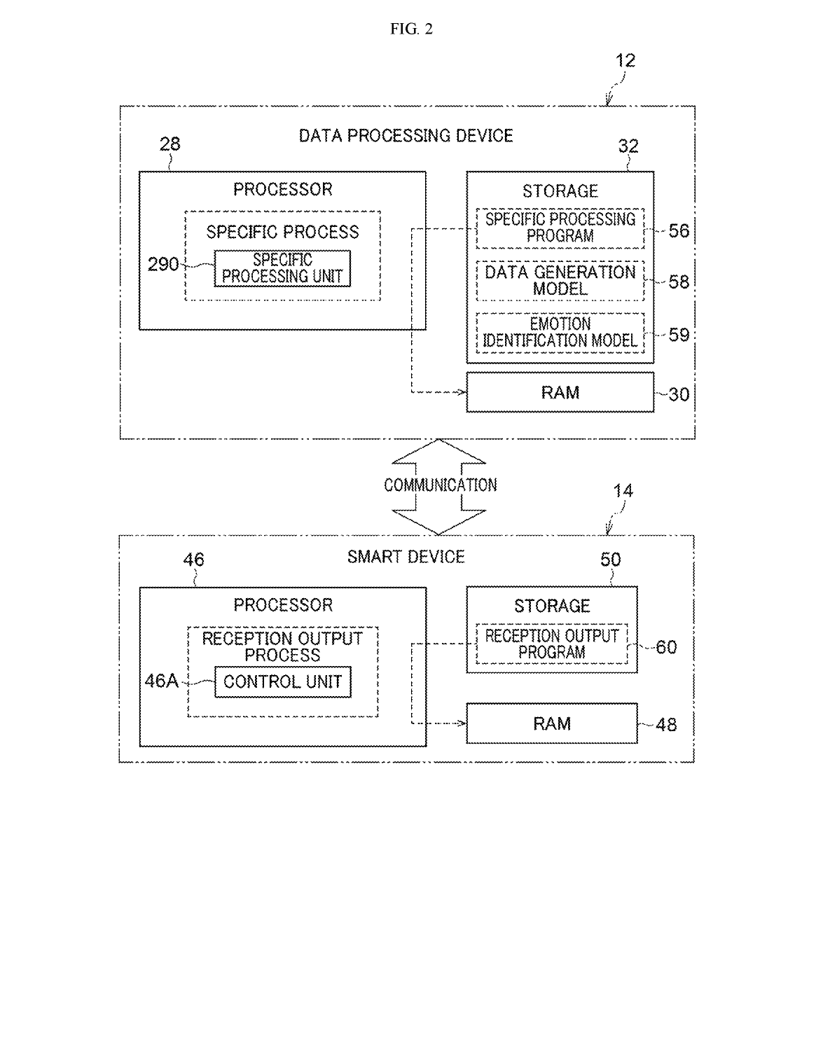

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, fraudulent activities using audio communication devices such as telephones have rapidly evolved, resulting in significant financial and psychological harm to users. Existing anti-fraud systems often suffer from delayed detection, high false positives, or insufficient real-time response, which limit their effectiveness in protecting users during ongoing calls. Therefore, there is a need for an advanced system capable of quickly and accurately detecting fraudulent activities in real-time by analyzing voice communications, providing immediate warnings and concrete defensive guidance to users, and continuously adapting through artificial intelligence technologies.

The specific processing by the specific processing unit 290 of the data processing device 12 in Example 1 is realized by the following means.

The present invention provides a server comprising a processor configured to generate a learning model for identifying fraudulent activities based on historical fraud data, convert audio information collected by an audio input device into character information using audio recognition technology, analyze the textual information through natural language processing, evaluate the risk of fraudulent activity in real time, generate warning and guidance information utilizing a generative artificial intelligence model, notify the user device immediately if fraud is suspected, and generate optimal training prompts to improve the system. This enables fast, accurate, and adaptive detection of fraudulent activity during audio communication, as well as the provision of timely and actionable guidance to users to prevent potential damages.

The term “learning model” refers to a computational model that is trained using historical data to identify specific patterns or features associated with fraudulent activities.

The term “audio input device” refers to any hardware component, such as a microphone, that captures audio signals from voice communications.

The term “audio information” refers to digital or analog data representing voice signals collected during audio communications.

The term “audio recognition technology” refers to software or algorithms that convert audio information into machine-readable text data.

The term “character information” refers to text data generated from audio signals via audio recognition technology, representing the contents of verbal communication.

The term “information processing apparatus” refers to a computational device, such as a server or processor, that processes received data and executes programmed instructions.

The term “user apparatus” refers to any device operated by an end user, such as a communication terminal or mobile device, that receives information or notifications.

The term “warning information” refers to a notification generated by the system to alert the user when there is a possibility of fraudulent activity.

The term “guidance information” refers to messages or instructions provided to the user, describing specific defensive actions or responses to potential fraudulent activity.

The term “generative artificial intelligence model” refers to a machine learning model trained to automatically produce text data, such as warning or guidance messages, based on provided inputs.

The term “natural language processing technology” refers to techniques and algorithms that enable a system to analyze and interpret human language in text format.

The term “prompt sentence” refers to a text input provided to an artificial intelligence model to guide its output or behavior, particularly in training or adapting models for fraud detection.

The term “real time” refers to the ability of the system to process, analyze, and respond to data as it is received, with minimal or no delay.

The term “historical fraud data” refers to previously recorded instances of fraudulent activities, used as training materials for building or improving a learning model.

The terminal, operated by the user, collects voice data during an audio communication such as a phone call. The terminal employs an audio recognition technology, for example, a cloud-based or local automatic speech recognition (ASR) engine such as Speech-to-Text services, to convert the raw audio information into character information in real time or near real time. Audio signals are recorded, properly digitized, and segmented as needed before transmission or processing.

The terminal then sends character information - including the recognized text of verbal interactions - to the server using a secure communication protocol. The server processes this text data with a learning model, which has been pre-trained using large quantities of historical fraud data. The learning model is configured as a machine learning-based classifier, such as a model based on natural language processing technology. Examples include architectures utilizing standard algorithms for classification, such as those possible with open-source frameworks or commercial NLP solutions.

The server evaluates the input text for fraudulent activity patterns. Warning information and guidance information are dynamically generated by the server, utilizing a generative artificial intelligence model, if the risk of fraud is detected. In generating warning and guidance messages, the system may use generative AI software, such as text generation modules based on large language models, to tailor instructions or warnings suited to the context of the detected risk.

The server then transmits the generated warning and guidance information back to the terminal. The terminal displays the warning information to the user with appropriate urgency, for instance, by overlaying a pop-up notification or visual indicator on the communication screen. The guidance information provides actionable, context-appropriate instructions to help the user avoid potential harm, such as “Do not share your account credentials” or “End the call if asked for sensitive data.”

The system includes the capability to process, analyze, and respond to data in real time by transmitting character information in partial segments and updating analysis dynamically as the conversation progresses. Moreover, the generative AI model is supplied with carefully constructed prompt sentences to optimize the model’s performance for fraud detection tasks.

A concrete example is as follows: The user receives a call, and the terminal records and transcribes verbal interactions such as, “Please provide the authentication code sent to your device.” The transcribed text is sent to the server for analysis. If the server’s model recognizes this pattern as high risk, the server generates and transmits a warning - such as “This call may be fraudulent. Do not share your authentication code” - which the terminal promptly displays to the user.

An example prompt sentence for the generative AI model is:

"List the specific audio features, transcription formats, and model architectures most effective for real-time detection of phone scams using speech recognition and natural language processing."

In this way, the invention makes use of commercially available audio collection devices, speech-to-text technologies, machine learning models for fraud detection, generative AI for messaging, and provides secure networked integration to deliver comprehensive and adaptive protection to users during audio communications.

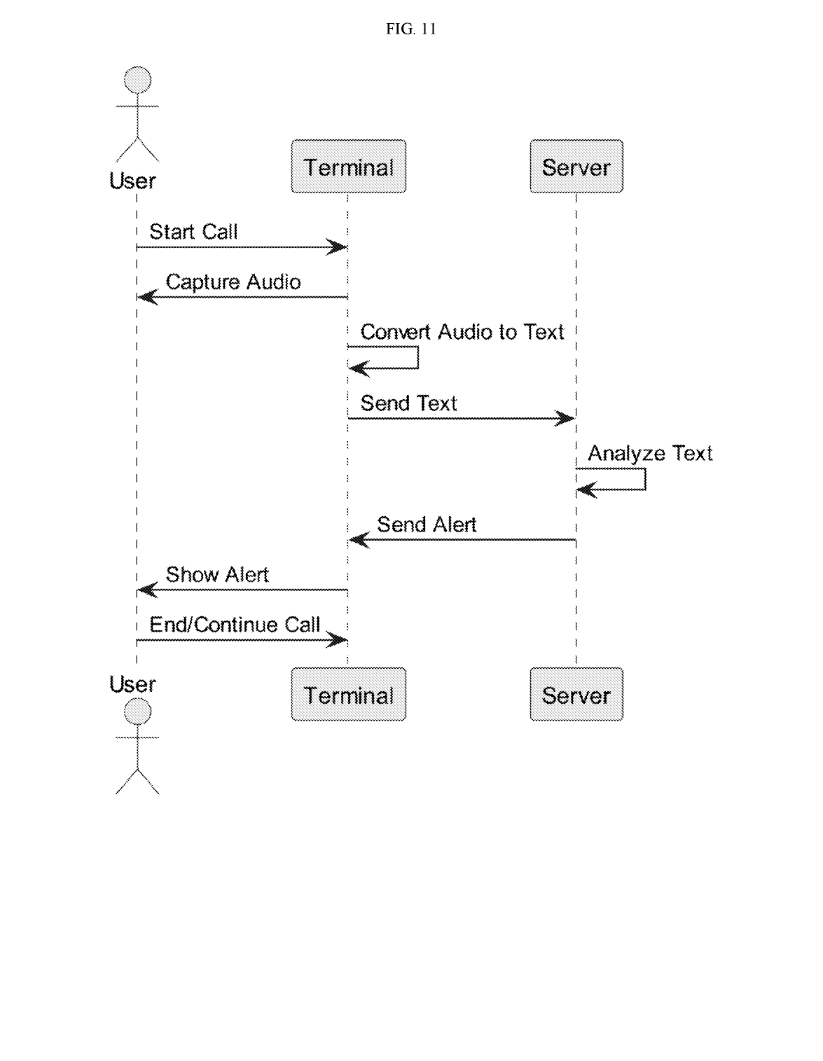

The following describes the processing flow using FIG. 11.

### Step 1:

The terminal activates its audio input device, such as an internal microphone, to capture the user’s voice during a phone call.

Input: Audio signals from the active call.

The terminal processes these analog signals using an analog-to-digital converter and temporarily stores the digitized audio data in a buffer.

Output: Digitized audio data representing the ongoing conversation.

### Step 2:

The terminal applies audio recognition technology, such as a speech-to-text engine, to the buffered audio data.

Input: Digitized audio data.

The terminal segments the audio stream into smaller portions, sends them to a speech recognition module (either on-device or via a cloud API), and collects the transcribed text responses.

Output: Character information in text format corresponding to the spoken words.

### Step 3:

The terminal transmits the character information to the server using a secure network protocol such as HTTPS.

Input: Character information (text) and associated metadata (such as timestamps or caller identification).

The terminal packages the text and metadata into a structured message and securely sends it to the server as soon as it is available to ensure near real-time processing.

Output: Structured data containing text information and metadata received by the server.

### Step 4:

The server receives and parses the structured data containing the character information and related metadata.

Input: Structured data with character information and metadata.

The server preprocesses the text (e.g., normalization, removal of extraneous symbols), then applies a learning model trained on historical fraud data. The learning model, which incorporates natural language processing technology, analyzes the text for keywords, patterns, or semantic clues that match fraudulent activity.

Output: An inference result scoring the likelihood of fraudulent activity.

### Step 5:

The server determines whether the analyzed conversation text meets or exceeds a predetermined fraud risk threshold.

Input: Inference result showing fraud probability score.

If the threshold is surpassed, the server generates warning information and detailed guidance information using a generative artificial intelligence model to compose suitable and context-appropriate messages.

Output: Warning message and guidance instructions prepared for the user.

### Step 6:

The server transmits the warning message and guidance instructions to the terminal.

Input: Warning message and guidance instructions.

The server formats the alert messages and sends them over a secure channel to the designated user terminal for immediate action.

Output: Delivery of specific alert and guidance content to the terminal.

### Step 7:

The terminal receives the warning and guidance messages and presents them to the user through the display and, optionally, audio or haptic feedback mechanisms.

Input: Alert and guidance content from the server.

The terminal activates a prominently visible notification interface, which may include pop-up dialogue, audible alerts, vibrations, and actionable interface buttons, such as “End Call” or “Report Scam.”

Output: Real-time alert and actionable options visibly and/or audibly presented to the user.

### Step 8:

The user reads or listens to the warning and guidance information and decides whether to end the call, refrain from sharing sensitive data, or take further recommended actions.

Input: Warning and guidance presented via the terminal interface.

The user makes decisions based on the level of risk communicated, such as terminating the call or following additional safety recommendations provided by the system.

Output: User’s defensive action, such as ending the call or withholding information, in direct response to the system’s guidance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Recently, fraudulent activities, such as telephone scams, have increasingly become more sophisticated, resulting in greater risks of individuals suffering financial loss or personal information leakage. Conventional fraud detection systems often fail to provide real-time alerts or adapt to the emotional state of users during communication, thereby lacking the necessary responsiveness and personalization required to effectively prevent such crimes. There is a need for a system that can not only detect potential fraudulent activity in real time but also assess and respond to the user’s psychological condition, ensuring immediate and appropriate guidance for the prevention of fraud.

The specific processing by the specific processing unit 290 of the data processing device 12 in Application Example 1 is realized by the following means.

The present invention provides a server comprising a processor configured to generate and maintain an information processing model for detecting fraudulent activity based on previous fraud cases, convert acoustic information from terminal devices into character information, utilize a generative artificial intelligence model to evaluate the likelihood of fraud, estimate the user’s emotional state from communication data, and dynamically adjust warning notifications and prevention guidelines based on both fraud risk and user emotion. This enables real-time detection and personalized response to fraudulent activities, timely warning notifications, and adaptive guidance that increases user safety and reduces the risk of loss or damage during suspicious communications.

The term “information processing model” refers to a computational model, such as a machine learning or artificial intelligence model, that is configured to analyze input data and determine patterns or risks associated with fraudulent activity.

The term “acoustic information” refers to electronic data representing audio signals, including spoken conversations, obtained from a communication device during real-time interactions.

The term “character information” refers to textual data generated by converting acoustic information, typically through speech-to-text processing, into a human- or machine-readable text format.

The term “terminal device” refers to an electronic communication apparatus, such as a smartphone, tablet, or other user-operated device, capable of acquiring, transmitting, and receiving data.

The term “subject” refers to an individual who is the intended user or recipient of the fraud detection, warning, and guidance functions provided by the system.

The term “emotion estimation” refers to the process of analyzing user-related data, including speech features and interaction patterns, in order to determine the emotional state, such as stress or anxiety, of the subject.

The term “warning notification” refers to a message or alert generated by the system and presented to the subject when a potential fraud risk is detected, intended to inform or warn the subject.

The term “action guidelines” refers to specific preventive or responsive recommendations provided to the subject by the system for mitigating the risks associated with detected fraudulent activity.

The term “generative artificial intelligence model” refers to an artificial intelligence model capable of processing input data, generating analysis or predictions, and outputting evaluation results, such as the likelihood of fraud, based on both learned patterns and dynamically supplied instruction sentences.

The term “instruction sentence” refers to a textual prompt or command inputted into a generative artificial intelligence model, designed to elicit specific analytical responses pertinent to fraud detection or feature evaluation.

The term “feedback information” refers to data provided by the subject following a system notification or interaction, which may include user reactions, experiences, or corrective inputs, with the purpose of improving system accuracy and responsiveness.

### Embodiment for Practicing the Invention

In one embodiment, the system consists of a server comprising a processor, and at least one terminal device operated by a user. The terminal device may be implemented as a communication device such as a smartphone, tablet, or other portable information terminal equipped with a microphone, communication module, and display.

The terminal acquires acoustic information by capturing the user's voice and the remote party’s voice during a communication session, such as a telephone call. Using speech-to-text software, the terminal converts the acquired acoustic information into character information. For example, an application programming interface or software library for speech recognition, such as a cloud-based speech-to-text API, may be used for this purpose. The terminal is additionally equipped with programming for extracting prosodic features - including pitch, intonation, tempo, and other voice parameters - using audio processing libraries such as librosa, and derives an emotion estimation by classifying the feature data with an emotion model implemented using a machine learning framework.

The terminal transmits both the converted character information and the emotion estimation results to the server over a secure communication channel, such as HTTPS.

The server receives the character information and emotion estimation data. The server preprocesses the character information (for example, by tokenizing using text processing software libraries like NLTK or spaCy) and then analyzes it using a generative artificial intelligence model configured for fraud detection, such as a text-based transformer model deployed via frameworks like PyTorch, TensorFlow, or machine learning deployment platforms. The generative AI model has been trained with prior examples of fraudulent activity and is able to process instruction sentences formulated for fraud detection.

For example, the server may input a prompt sentence to the generative AI model such as:

"Does this conversation contain indicators of fraud? Please highlight any specific fraudulent phrases and consider if the user is showing emotional distress."

or

"Analyze this telephone conversation transcript and determine if there are signs of fraud or classic scam phrases. Also, note if the user seems anxious or stressed."

Based on the generative AI model’s output and the provided emotion estimation data, the server determines the likelihood of fraudulent activity, and, if appropriate, generates a warning notification. The warning notification’s content and presentation format are automatically adjusted according to the user’s current estimated emotional state. More urgent and prominent warnings are displayed if user stress is detected.

The terminal receives the warning message and provides it to the user by displaying a text notification and/or playing an audio alert using built-in speakers. The user is able to refer to the warning and the preventive action guidelines, which offer specific suggestions such as not providing confidential information or ending the call.

After reviewing the warning, the user may also provide feedback regarding the warning’s relevance or accuracy by interacting with the terminal’s interface. The terminal transmits this feedback to the server. The server stores the accumulated feedback and periodically applies it to retrain or fine-tune the generative AI model and the emotion estimation model, thereby improving the system’s detection and user guidance performance.

For instance, if a user receives a call from an unknown party asking for account authentication, and the terminal’s emotion analysis detects increased agitation in the user’s voice, the server determines that the risk of fraud is high, composes an urgent warning such as “This call may be a scam. Please do not provide any personal information,” and displays this message prominently on the terminal. The user, upon seeing and hearing the warning, refrains from complying with the suspicious request, and may report this feedback through the application interface, which is used for future improvements.

Through the above configuration and operational procedures, the invention enables real-time detection, adaptive warning notification, and continual refinement for enhanced user protection against communication-based fraud.

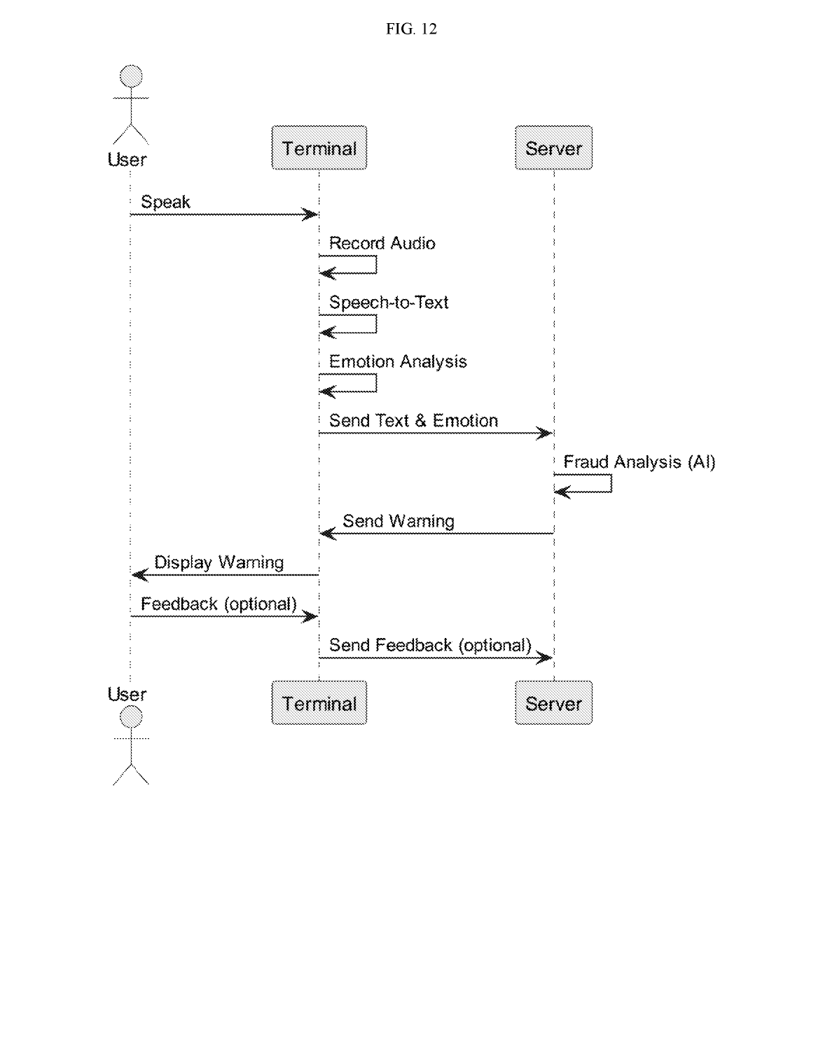

The following describes the processing flow using FIG. 12.

### Step 1:

The terminal captures acoustic information by recording the ongoing conversation during a communication session using its microphone hardware. As input, the terminal receives real-time audio data from both the user and the other party. The terminal preprocesses the audio to reduce noise and adjusts the sampling rate as needed. The output is a cleaned digital audio file ready for analysis.

### Step 2:

The terminal converts the preprocessed acoustic information into character information using a speech-to-text engine, such as a cloud-based speech recognition API. The input for this step is the cleaned digital audio file from Step 1. The terminal transmits this file to the speech-to-text service, receives the transcribed text, and formats the result. The output is a text transcript of the conversation.

### Step 3:

The terminal analyzes prosodic features from the recorded audio using digital signal processing libraries, extracting parameters such as pitch, intensity, and speech rate. The input is the same preprocessed audio file used in Step 2. Feature extraction algorithms are applied, and then an embedded machine learning model classifies the emotional state (such as neutral, anxious, or stressed). The output is a set of emotion estimation data.

### Step 4:

The terminal creates a data package containing the character information (the transcribed text) and the emotion estimation data. The input is the text transcript and the emotion data produced in Steps 2 and 3. The terminal serializes and formats this data into a structured format, such as JSON. The output is a data package ready for transmission.

### Step 5:

The terminal transmits the data package to the server over a secure communication protocol, such as HTTPS. The input is the data package from Step 4. The terminal opens a network session, sends the data, and waits for acknowledgment. The output is confirmation that the server has received the data.

### Step 6:

The server preprocesses the received character information by applying natural language processing techniques, such as tokenization and removal of stop words, using text processing libraries. The input is the transcribed text from the terminal. The server prepares the processed text for further analysis. The output is a cleansed text dataset.

### Step 7:

The server analyzes the processed character information using a generative AI model for fraud detection, such as a transformer-based language model. The input is the cleansed text dataset from Step 6. The server generates a prompt sentence, such as “Does this conversation contain indicators of fraud? Please highlight any specific fraudulent phrases and consider if the user is showing emotional distress." The generative AI model is executed with this prompt, and the output is a fraud risk assessment result, which includes detected suspicious phrases and a fraud probability score.

### Step 8:

The server evaluates both the fraud risk assessment result from Step 7 and the emotion estimation data included in the initial data package. The input consists of the AI-generated fraud probability and the user’s emotional state. The server uses a rule-based or statistical logic to determine the urgency level and content of the warning notification. The output is a warning message tailored to the detected risk and emotional condition.

### Step 9:

The server serializes and sends the warning message and guidance instructions to the terminal. The input is the warning message generated in Step 8. The server transmits this data via the established secure channel. The output is confirmation of successful delivery.

### Step 10:

The terminal receives the warning message and guidance instructions. The input is the data packet from the server. The terminal displays the warning visually on the screen, possibly highlighting it with colors or icons, and may trigger audio or vibration alerts for urgency. The terminal also provides textual or audio guidance regarding preventive actions. The output is the warning and advice presented to the user.

### Step 11:

The user reads or listens to the warning and action guidelines provided by the terminal. The input is the warning and guidance from the display or speakers. The user decides how to respond, such as ending the call, refraining from sharing sensitive information, or proceeding if deemed safe. The output is the user's protective action.

### Step 12:

The user has the option to submit feedback regarding the warning’s accuracy or usefulness using the terminal interface. The input is user feedback entered via buttons, text fields, or voice comments. The terminal encodes and transmits this feedback to the server. The output is a feedback record received by the server for future system improvements.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In recent years, fraudulent activities utilizing telecommunication channels have become increasingly sophisticated, making it difficult for users to identify and avoid scams in real time. Moreover, conventional systems do not adequately detect and respond to rapid changes in the emotional state of users during suspicious communications. As a result, users may become victims of fraud without being aware of emotional manipulation or the urgency of the situation. Accordingly, there is a need for a system that can promptly assess abnormal behavior and consider the user’s emotional state to provide real-time, context-aware warnings and guidance.

The specific processing by the specific processing unit 290 of the data processing device 12 in Example 2 is realized by the following means.

The present invention provides a server comprising a processor configured to generate a machine learning algorithm for identifying abnormal behavior based on past cases, convert acoustic information into text information, extract emotional state information from acoustic information, and evaluate the possibility of abnormal behavior and the user’s emotional state using the machine learning algorithm. The processor further generates alert and guidance information using a generative artificial intelligence model with prompt sentences, and notifies the user in real time through a user terminal utilizing both audio and visual outputs, especially when sudden changes in emotional state or abnormal behavior are detected. This enables timely and personalized alerts that help users recognize and respond to potentially fraudulent communications by taking appropriate actions.

The term “machine learning algorithm” refers to a computational method that is trained using previous data to identify and predict patterns of abnormal behavior or fraudulent activity.

The term “acoustic information” refers to data representing audio signals, including speech or other sounds, obtained from a communication device during a conversation.

The term “text information” refers to data in written or character-based format that is generated by converting acoustic information through a speech-to-text process.

The term “emotional state information” refers to data that expresses or quantifies the psychological condition of a user, such as stress, anxiety, or calmness, which is extracted from acoustic features.

The term “information acquisition device” refers to an electronic apparatus capable of collecting acoustic information, such as a microphone-equipped communication terminal.

The term “feature values” refers to quantitative or qualitative attributes that are derived from textual or acoustic data and are used as inputs for further analysis by machine learning algorithms.

The term “natural language analysis technology” refers to a set of computational techniques for understanding, processing, and extracting semantic or syntactic information from text data.

The term “alert information” refers to messages or notifications generated to warn a user about a detected possibility of abnormal behavior or fraudulent activity.

The term “guidance information” refers to supportive instructions or actionable advice presented to a user in response to detected alerts, to help prevent damage or loss.

The term “user terminal” refers to a communication device, such as a smartphone or computer, through which the user interacts and receives notifications.

The term “generative artificial intelligence model” refers to an artificial intelligence system capable of producing natural language outputs, such as warning and guidance messages, based on specific input prompts.

The term “prompt sentence” refers to a structured input or instruction provided to a generative artificial intelligence model in order to produce relevant natural language outputs.

The term “real time” refers to processing and response actions occurring with minimal delay, sufficient to provide feedback or notifications during an ongoing communication.

One embodiment for carrying out the present invention will be described in detail below. This embodiment allows a person skilled in the art to implement the claimed invention using general-purpose hardware and well-known software components.

The server comprises a processor that is configured to generate and deploy a machine learning algorithm trained using historical data on abnormal behaviors, such as known fraud or scam communication patterns. The server may utilize machine learning frameworks, for example, a deep neural network implemented with a machine learning library such as TensorFlow or PyTorch, for the purpose of identifying speech and text patterns indicative of abnormal communication.

The terminal, which may be a smartphone, tablet, personal computer, or other communication equipment, is provided with a microphone and audio acquisition software such as Android AudioRecord API or iOS AVFoundation. The terminal records audio during a user communication session and preprocesses the data (for instance, by normalizing volume and filtering noise) using software libraries such as librosa. The terminal may also extract features relevant to emotion analysis using a software toolkit such as OpenSMILE or any equivalent feature extraction framework.

The terminal converts the acquired acoustic information into text information through a speech-to-text conversion process, using a commercial or open-source speech recognition system, for example, the Google Speech-to-Text API or equivalent. The same or another process analyzes the acoustic features (such as pitch, tone, and speech rate) to determine the emotional state information of the user, classifying the state as “anxiety,” “stress,” or “calm,” using an emotion recognition model (that may run on-device using technologies such as TensorFlow Lite or be executed by the server).

The terminal sends both the transcribed text information and the extracted emotional state information to the server via a secured communication protocol, for example, HTTPS with TLS encryption. Upon receiving the data, the server evaluates the possibility of abnormal behavior using the machine learning algorithm, and simultaneously assesses the user’s emotional state.

If abnormal behavior is detected, the server generates alert information and guidance information for the user. The content and urgency of these notifications are controlled by evaluating both the likelihood of abnormal behavior and the user’s current emotional state. The server employs a generative artificial intelligence model, such as a large language model implemented with a platform (e.g., GPT or equivalent), to generate context-sensitive, natural language outputs. These outputs are produced in response to specific prompt sentences that summarize the current risk and emotional context.

### Examples of prompt sentences include:

“Generate an urgent warning for the user: the conversation contains suspicious money transfer requests and the user’s emotional state is anxious.”

“Draft a clear notification alerting the user to a probable scam detected based on both the conversation content and elevated stress levels.”

“Suggest actions for the user after receiving this warning: transcript = ‘Please say your bank details out loud’; emotion = ‘fear detected’.”

The server transmits the generated alert information and guidance information to the terminal, which in turn notifies the user by voice (using a text-to-speech system such as Google TTS or the iOS Speech framework) and by visual display, ensuring that the user is promptly warned and informed. The user, upon receiving these notifications, can take recommended actions such as ending the ongoing communication or seeking further assistance.

For example, if a user is speaking on the phone and their speech reveals elevated anxiety and the transcribed content contains requests to transfer money, the system may generate the warning: “Warning! This conversation may be fraudulent. Please end the call immediately and do not provide any sensitive information.” This message is both displayed on the terminal and read aloud to the user to maximize awareness.

In this way, the present invention enables real-time, intelligent, and user-specific responses to suspected fraudulent communications, combining machine learning, emotion analysis, and generative artificial intelligence to provide comprehensive protection and guidance for users.

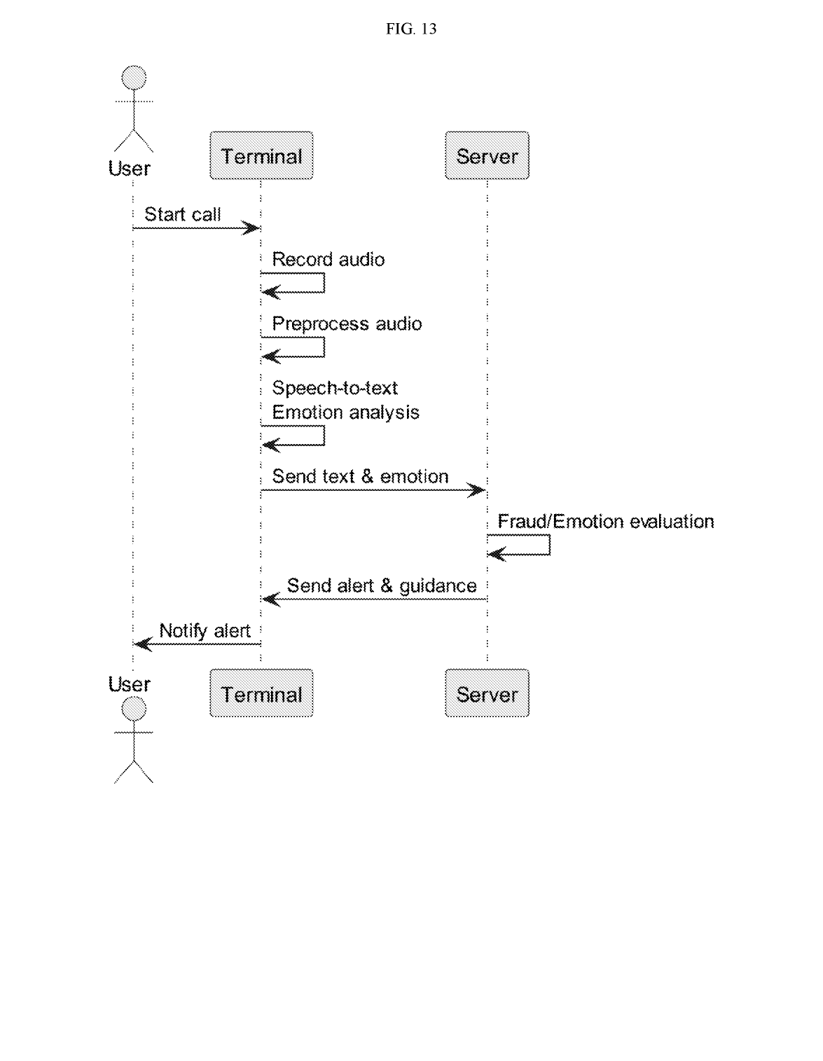

The following describes the processing flow using FIG. 13.

### Step 1:

Terminal detects the start of a communication session (such as a phone call) and activates the microphone to begin recording audio data in real time. The input for this step is the user’s live speech during the call. The terminal uses audio capture software (such as Android AudioRecord or iOS AVFoundation) to continuously acquire and buffer the acoustic information. The output is a stream of raw audio data.

### Step 2:

Terminal preprocesses the raw audio data by removing background noise and normalizing audio levels using a signal processing library such as librosa. The input is the buffered raw audio stream. The terminal then separates the cleaned audio into fixed time windows (such as 10-second segments) for further analysis. The output is a set of noise-reduced, normalized audio data segments.

### Step 3:

Terminal converts each audio segment into text information using a speech-to-text engine, such as a speech recognition API. The input is a normalized audio segment. The terminal applies the speech-to-text process and outputs a corresponding textual transcript of the user’s spoken content for each segment.

### Step 4:

Terminal extracts vocal features relevant to emotion analysis from each normalized audio segment, such as pitch, tone, intensity, and speech rate. This is done with an emotion recognition tool like OpenSMILE. The input is the normalized audio segment, and the output is a set of quantitative features that describe the speaker’s emotional state for that segment.

### Step 5:

Terminal applies an emotion classification model (which may run locally using TensorFlow Lite or remotely on the server) to the extracted features, classifying the user’s emotional state (such as “calm,” “anxious,” or “stressed”). The input is the vector of emotion features, and the output is a label and/or score that quantifies the speaker’s emotion in that segment.

### Step 6:

Terminal packages the textual transcript and the emotional state information into a structured data package. The input is the transcript and emotion classification result for each segment. The terminal encrypts this package and sends it securely to the server. The output is a transmission of structured data via a secure communication channel (such as HTTPS).

### Step 7:

Server receives the structured data from the terminal and stores it in persistent memory (such as a database). The input is the transcript and emotional state information for each segment. The server processes the transcript, applying a pre-trained machine learning algorithm for anomaly/fraud detection (implemented in frameworks such as TensorFlow or PyTorch). The output is a risk score indicating the likelihood of abnormal behavior or fraud.

### Step 8:

Server analyzes the emotional state data to assess the urgency and the user’s susceptibility. The input is the emotional state information for each segment. The server applies logical rules or a secondary model to quantify the user’s stress or anxiety level. The output is a measure of urgency or risk related to the user’s emotional state.

### Step 9:

Server generates alert information and guidance information for the user. The input is the fraud/anomaly risk score and the user’s emotional risk measures. The server uses a generative AI model to create an alert message, supplying a prompt sentence that combines the risk context and emotional analysis. The output is a contextually appropriate warning and suggested action for the user (for example, “Warning: This call may be fraudulent. Please end the call immediately.”).

### Step 10:

Server sends the generated alert and guidance information to the terminal. The input is the generated warning message and recommended user action. The terminal receives the data and triggers the notification functions: visual alert using the display and voice announcement using the text-to-speech engine. The output is both an on-screen notification and an audible warning delivered to the user.

### Step 11:

User receives the warning and guidance information. The input is the terminal’s on-screen and voice notification. The user interprets the alert and may take the recommended action, such as ending the call or refraining from providing sensitive information. The output is the user’s action in response to the system notification.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In recent years, damage caused by telephone fraud and similar deceptive acts has been increasing, and it has become an urgent issue to prevent harm before it occurs. Traditional systems are limited in their ability to accurately detect fraudulent activities and to provide users with immediate and interactive warnings or countermeasures based on both linguistic and emotional cues. In particular, real-time analysis of a user's emotional state during a conversation and integration with fraud detection to produce personalized warnings is difficult with conventional technology. There is also a need for flexible warning generation utilizing advancements in artificial intelligence.

The specific processing by the specific processing unit 290 of the data processing device 12 in Application Example 2 is realized by the following means.

The present invention provides a server comprising a processor configured to convert audio information from a communication terminal device into character information, extract audio features, generate a machine learning apparatus for identifying fraudulent activity based on past fraudulent cases, evaluate the probability of fraud from the character information, estimate the user's emotional state from the audio features, generate and deliver warning and countermeasure information according to both results, adjust such information based on the estimated emotional state, and use a generative artificial intelligence model to produce and output further warning content. This enables precise, real-time, and individualized warnings and countermeasure notifications tailored to both the detected fraud risk and the emotional state of the user, thereby improving prevention and response to fraudulent activity.

The term “audio information” refers to electronic data representing sound signals, particularly those derived from human speech during communication via a terminal device.

The term “communication terminal device” refers to an electronic apparatus, such as a smartphone or computer, used by a user for transmitting and receiving data, including audio signals.

The term “character information” refers to textual data produced by converting audio information, such as transcribed speech from voice inputs.

The term “audio features” refers to quantifiable characteristics extracted from audio information, such as pitch, tone, speech rate, volume, and rhythm, which can be analyzed to assess speaker attributes or emotional states.

The term “machine learning apparatus” refers to a computational system trained on historical data that utilizes algorithms to recognize patterns and make predictions, such as detecting fraudulent activity.

The term “fraudulent activity” refers to actions or patterns identifiable through analysis that are indicative of deception, impersonation, or other illicit attempts to obtain personal or sensitive information.

The term “emotion state analysis apparatus” refers to a computational system designed to process audio features and estimate the psychological or emotional condition of the user, such as stress, anxiety, or calmness.

The term “warning information” refers to notification data generated to alert the user about the potential of fraudulent activity, based on the evaluation of conversation content and user emotional state.

The term “countermeasure information” refers to specific instruction data provided to the user, indicating appropriate actions to protect themselves from suspected fraudulent activity.

The term “generative artificial intelligence model” refers to an artificial intelligence system capable of producing content, such as warning messages or instructions, in response to structured data inputs and prompt sentences.

The term “instruction sentence” refers to a structured prompt or query formulated to elicit a relevant response from a generative artificial intelligence model, such as generating a warning message based on provided analysis results.

One embodiment for implementing the present invention is described as follows.

A server and at least one communication terminal device constitute the core system. The communication terminal device may be a mobile phone, a smartphone, a personal computer, or any electronic apparatus equipped with a microphone and capable of two-way communication with the server via a network. The terminal device is installed with application software that records user audio during a call session and transmits both the raw audio data and the transcribed character information to the server. Industry-standard hardware, such as commercially available smartphones and general-purpose servers, may be used. Software for speech-to-text conversion, such as a cloud-based speech recognition API, is employed to create the character information from the audio signal.

The server is equipped with a processor that performs a series of data analysis and management tasks. First, the server receives character information (converted from user speech by the terminal) and also receives audio features extracted from the audio stream. The audio features, such as pitch, tone, speed, and volume, may be extracted on the terminal device using an open-source library (e.g., librosa) or specialized frameworks included in mobile development environments. Alternatively, the server can receive the raw audio stream and extract features using server-side analysis tools such as OpenSMILE or custom software realized in high-level programming languages.

The server includes a machine learning apparatus, which may be constructed using platforms such as TensorFlow or PyTorch, and is trained on relevant datasets of fraudulent and non-fraudulent communication patterns. The model leverages natural language processing techniques to classify the incoming character information and estimate the likelihood of fraudulent activity. Additionally, the server operates an emotion state analysis apparatus, which is another algorithmic or neural network model tasked with interpreting the incoming audio features to estimate the user's psychological state. Such emotion recognition software may rely on existing toolkits (for example, OpenSMILE or IBM Watson Tone Analyzer), or alternatively, proprietarily-developed neural networks.

If the system detects a high probability of fraudulent activity (based on the processed character information) and/or identifies emotional states such as stress or anxiety (from the audio features), the server determines the urgency and content of warnings and countermeasures to be sent back to the user’s terminal. The message content and presentation method (for example: text notification, audio guidance) are adjusted dynamically via the server's processor in response to the user's emotional state. The terminal device is configured to immediately display or announce the warning or advice according to the server’s instruction.

The server may further employ a generative artificial intelligence model, such as a large language model available via API, to generate or refine the warning messages and countermeasure information provided to the user. In this case, the server constructs an instruction sentence (prompt) containing analytic context and results and submits this to the generative AI model. The server then retrieves the resulting output and delivers it to the terminal for presentation to the user.

For example, during a suspicious telephone call, when the user is asked, "Could you give me your credit card information?", the terminal device records and transcribes this into character information. The terminal also extracts from the user’s speech a high-pitched tone and rapid speech speed, indicative of stress. The server receives both datasets, and the machine learning apparatus evaluates a high possibility of fraud in the conversation. The emotion state analysis apparatus also determines that the user is anxious. The server then creates an urgent warning message, such as "Urgent: This call appears to be a scam. Hang up immediately and contact your financial institution." Optionally, the server constructs a prompt for the generative AI model and uses its output to provide refined advice for the user.

An example of a prompt sentence sent to the generative AI model is as follows:

"Analyze this transcript and audio features. If you find any sign of fraud and the user is stressed, generate a warning alert and suggest next steps for the user."

Thus, the present invention may be realized using general-purpose hardware such as smartphones and servers, and standard software components for speech recognition, machine learning, and emotion analysis, with the flexibility to integrate generative artificial intelligence as a content creation assistant for user communication. The system may be implemented as a cloud-based service or using a distributed architecture, depending on the particular application's demands for real-time response and security. The invention is not limited to the above described embodiment, and various modifications may be carried out within the scope of the invention.

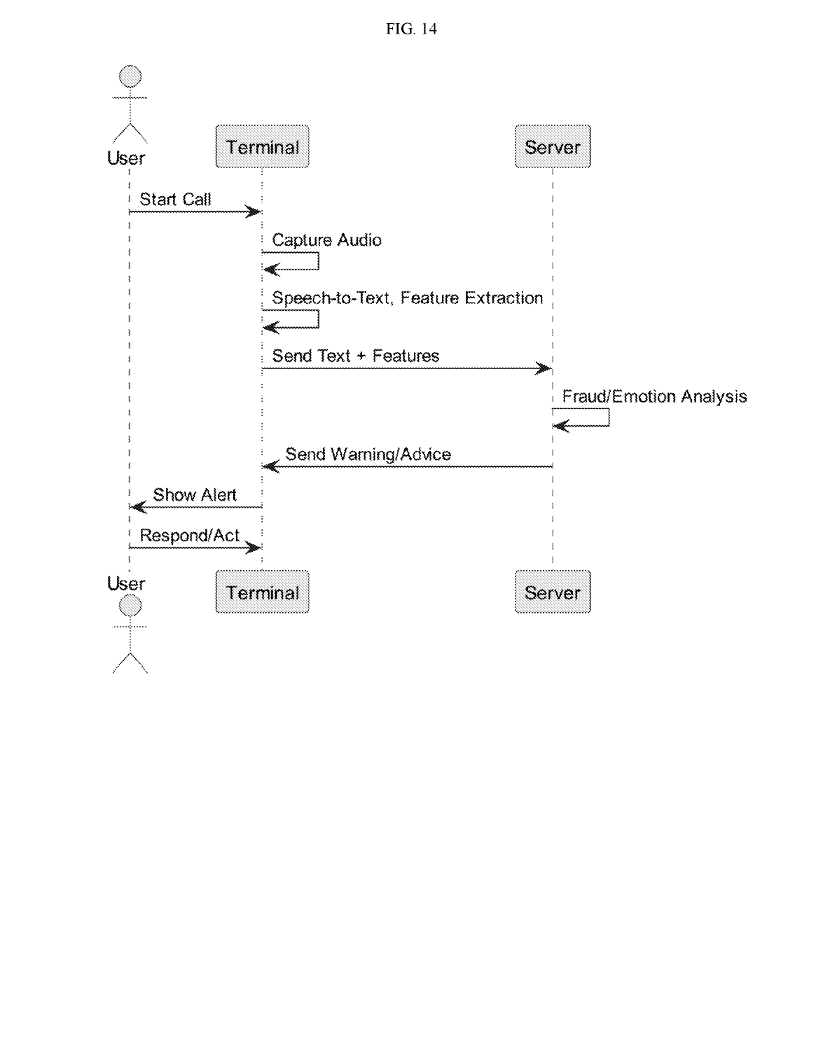

The following describes the processing flow using FIG. 14.

### Step 1:

The terminal captures the user's voice in real-time during a call using its built-in microphone. The input is raw audio data containing speech signals. The terminal processes this input by temporarily storing the audio data and forwarding it to an audio processing module.

### Step 2:

The terminal converts the captured raw audio data into character information using a speech-to-text engine, such as a cloud-based speech recognition API. The input is the stored raw audio data, and the output is a text transcript representing the user’s spoken words. The terminal also extracts audio features such as pitch, tone, and speech rate from the same raw audio data using an audio analysis library. The output is a feature vector representing the user's voice characteristics.

### Step 3:

The terminal packages both the character information (text transcript) and the extracted audio feature vector into a structured message, such as a JSON object. The input is the text transcript and the feature vector. The terminal transmits this message securely to the server over a communications network.

### Step 4:

The server receives the structured message from the terminal. The input is the combined character information and audio feature vector. The server preprocesses the text data (e.g., normalization and tokenization) and evaluates the likelihood of fraudulent activity using a machine learning apparatus trained on historical cases. The output is a fraud risk score or classification.

### Step 5:

The server analyzes the audio feature vector using an emotion state analysis apparatus. The input is the audio feature vector. The server applies algorithms or a neural network for emotion recognition to estimate the user's current emotional state, such as stress or anxiety. The output is an emotion label or probability distribution across emotional states.

### Step 6:

The server integrates the fraud risk score and the detected user emotional state to determine the urgency and specific content of warning and countermeasure information. The input includes the fraud risk score and the emotion label. The server formulates a warning message and recommended user actions, dynamically adjusting the message content or display method based on the user's emotion.

### Step 7:

The server optionally generates a prompt sentence containing analytic context and results, and sends this prompt to a generative AI model. The input is the prepared prompt sentence and relevant structured data. The server receives a generated warning message or advice from the generative AI model, and selects or integrates the message for the user. The output is the final warning and countermeasure message.

### Step 8:

The terminal receives the final warning and countermeasure message from the server. The input is the message received from the server. The terminal displays this warning and countermeasure information to the user via a graphical user interface or by voice guidance, with the urgency of the alert adjusted according to the user's emotional state. The output is the visible or audible notification provided to the user.

### Step 9:

The user observes or hears the provided warning and countermeasure information through the terminal. Based on this output, the user takes appropriate action such as ending the call or contacting a trusted party. The input is the presented information, and the output is the user's response behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

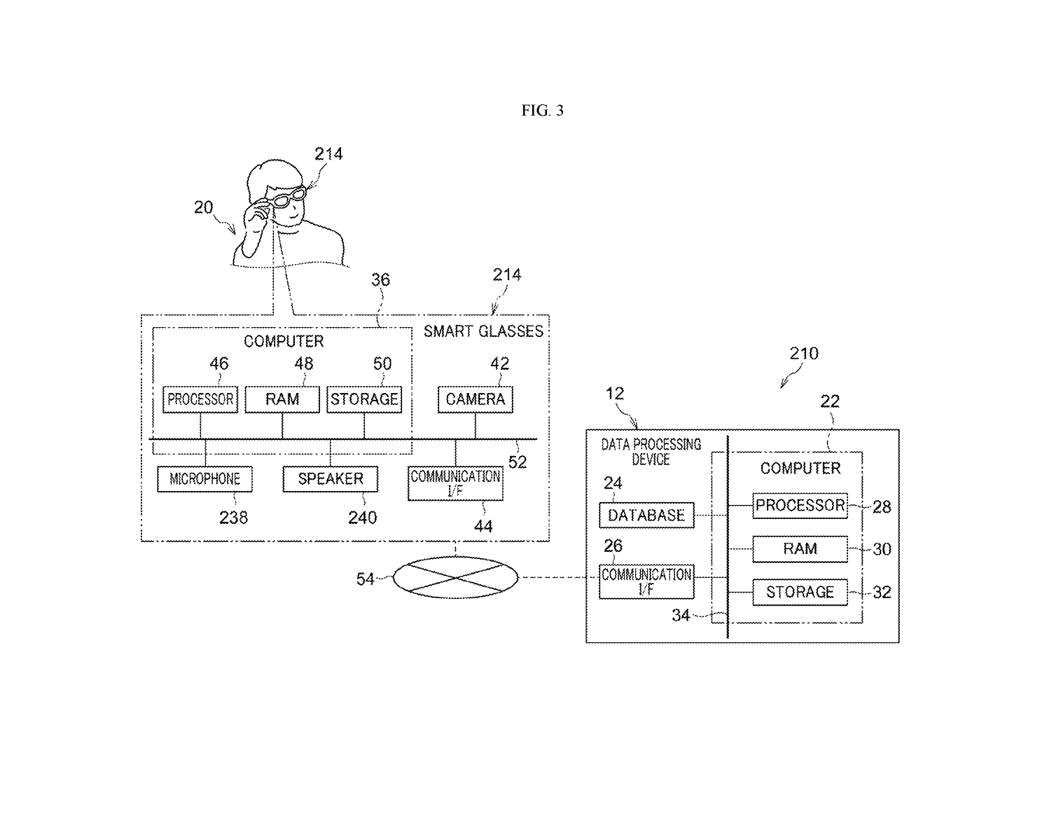

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

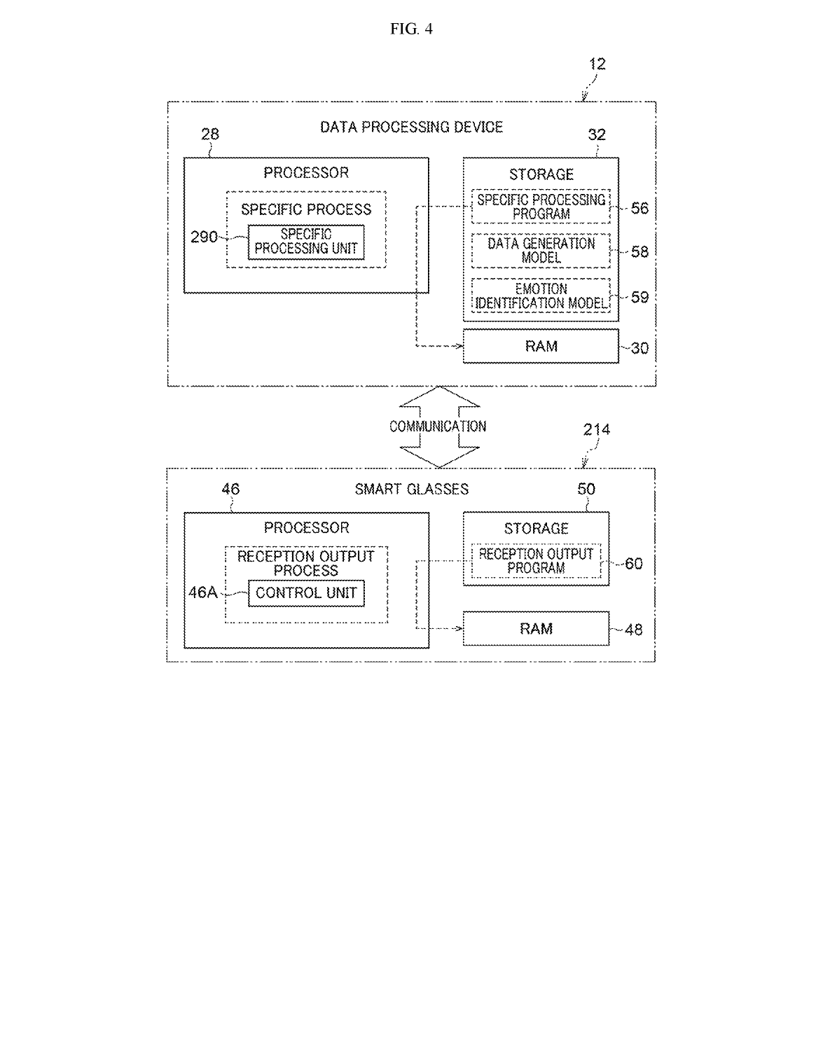

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

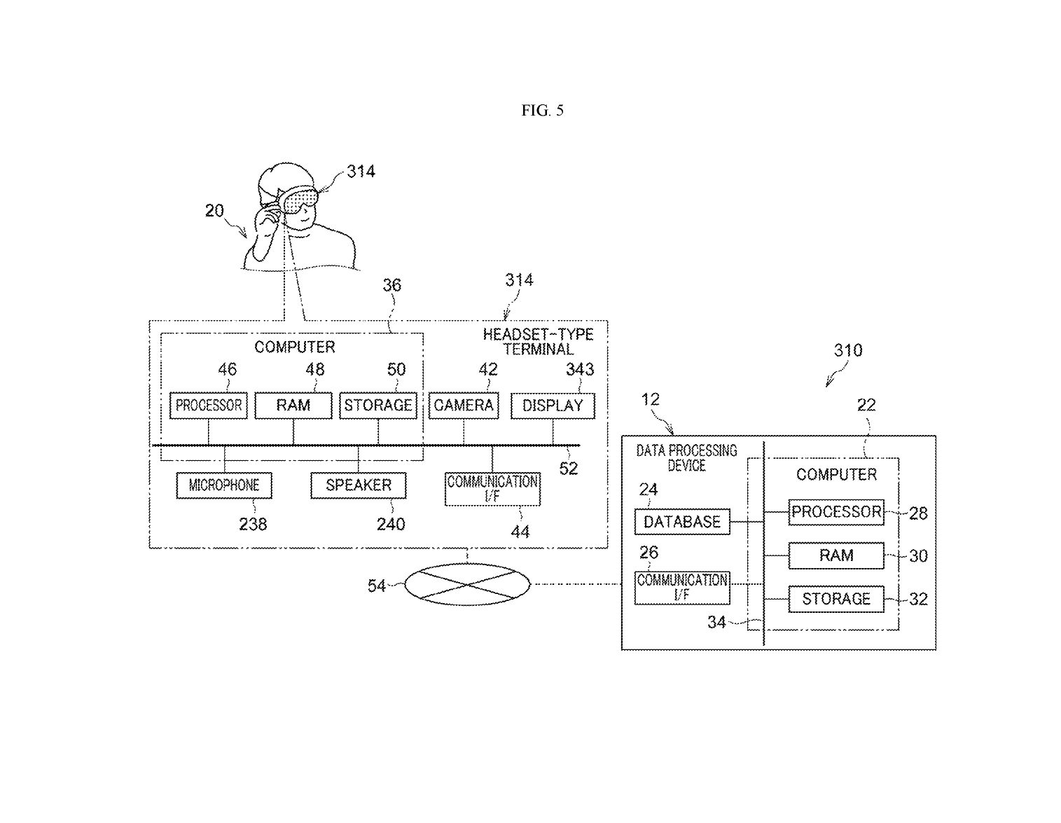

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

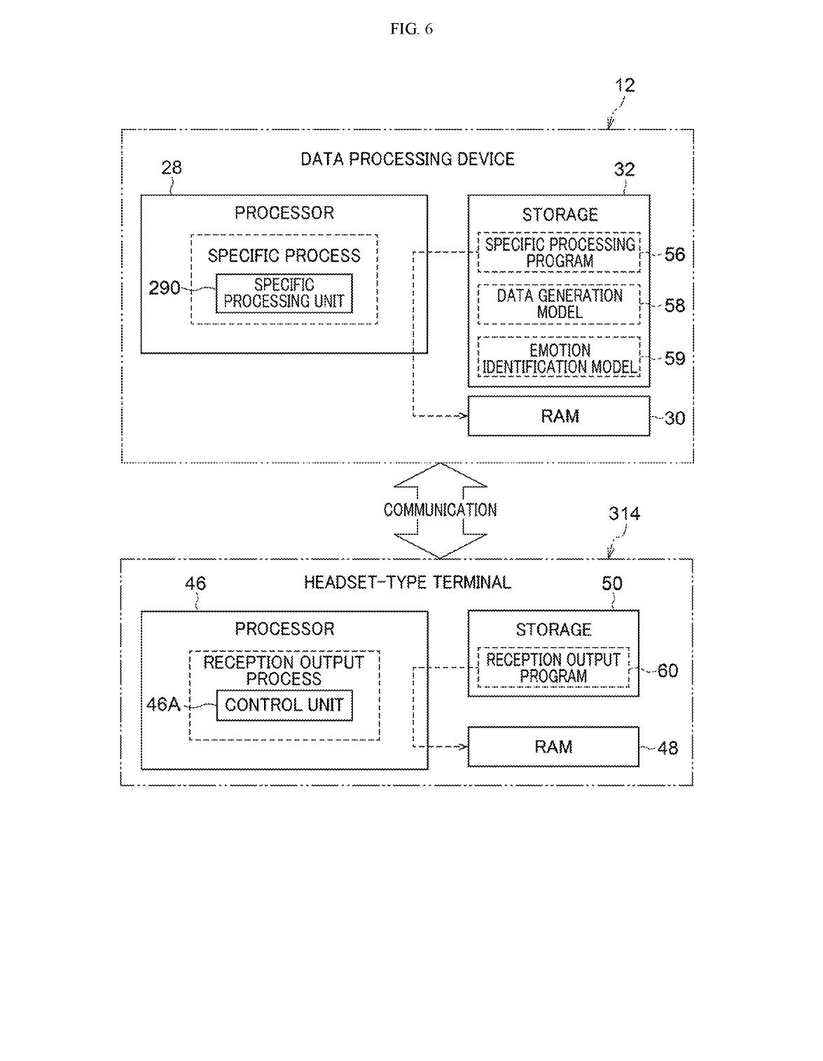

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

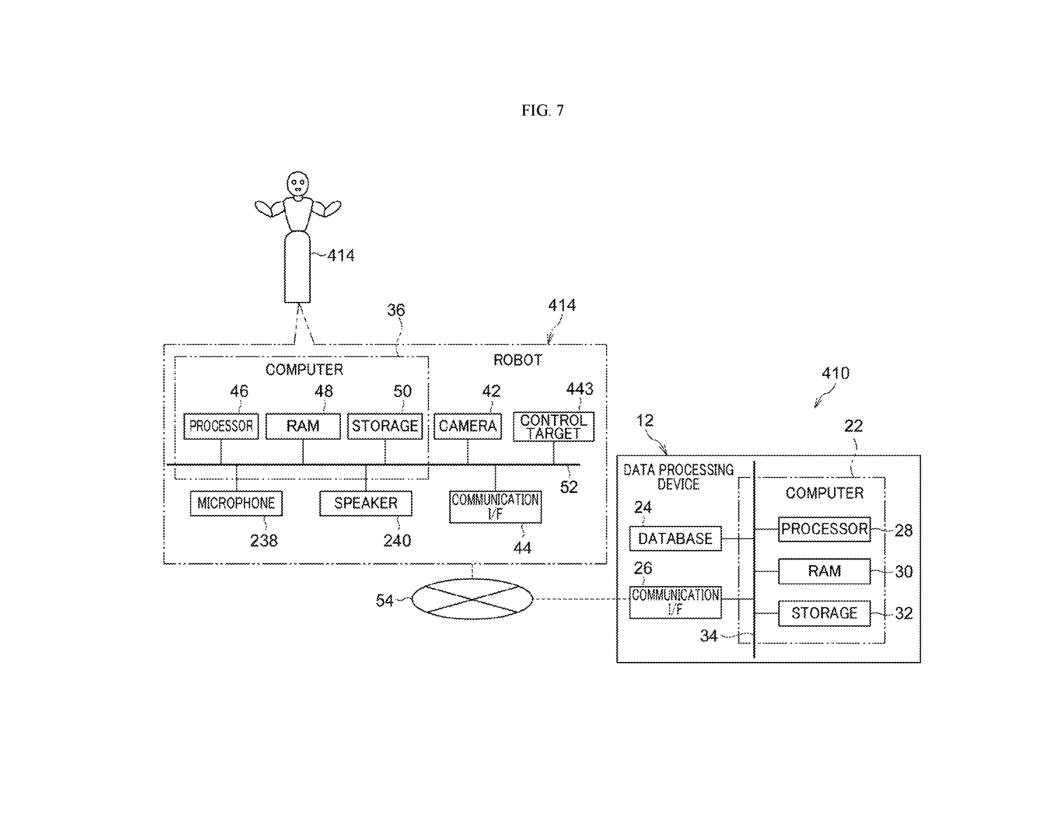

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

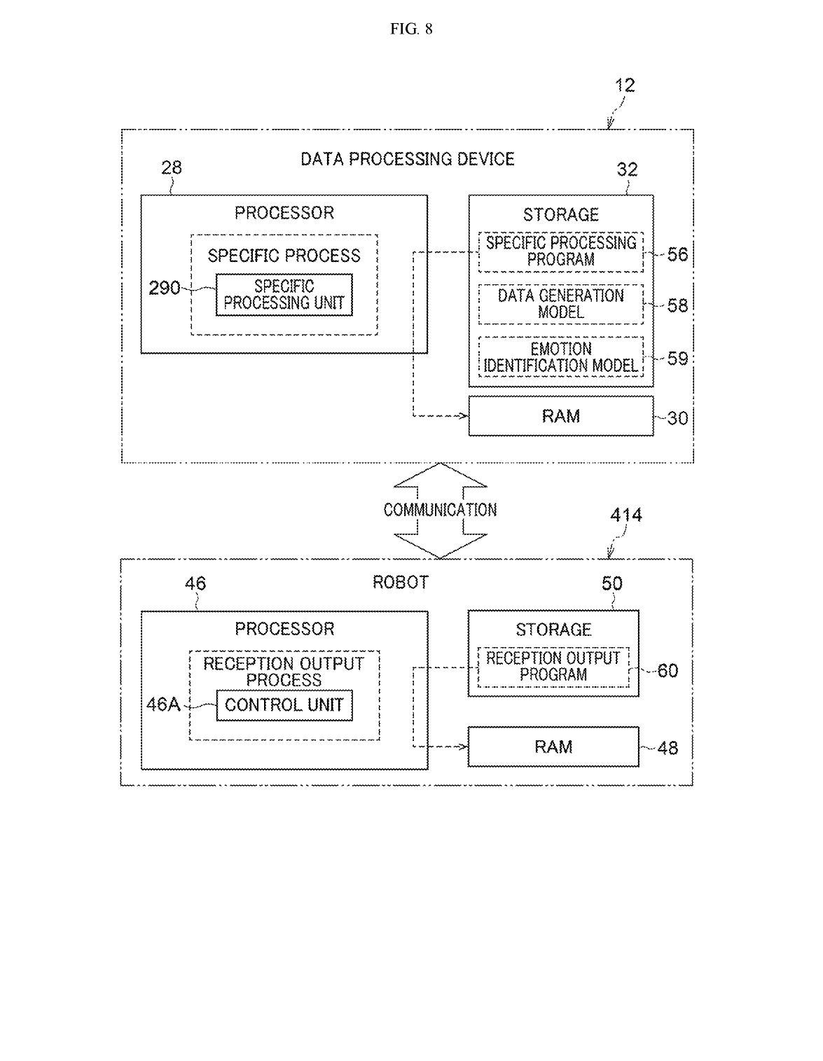

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

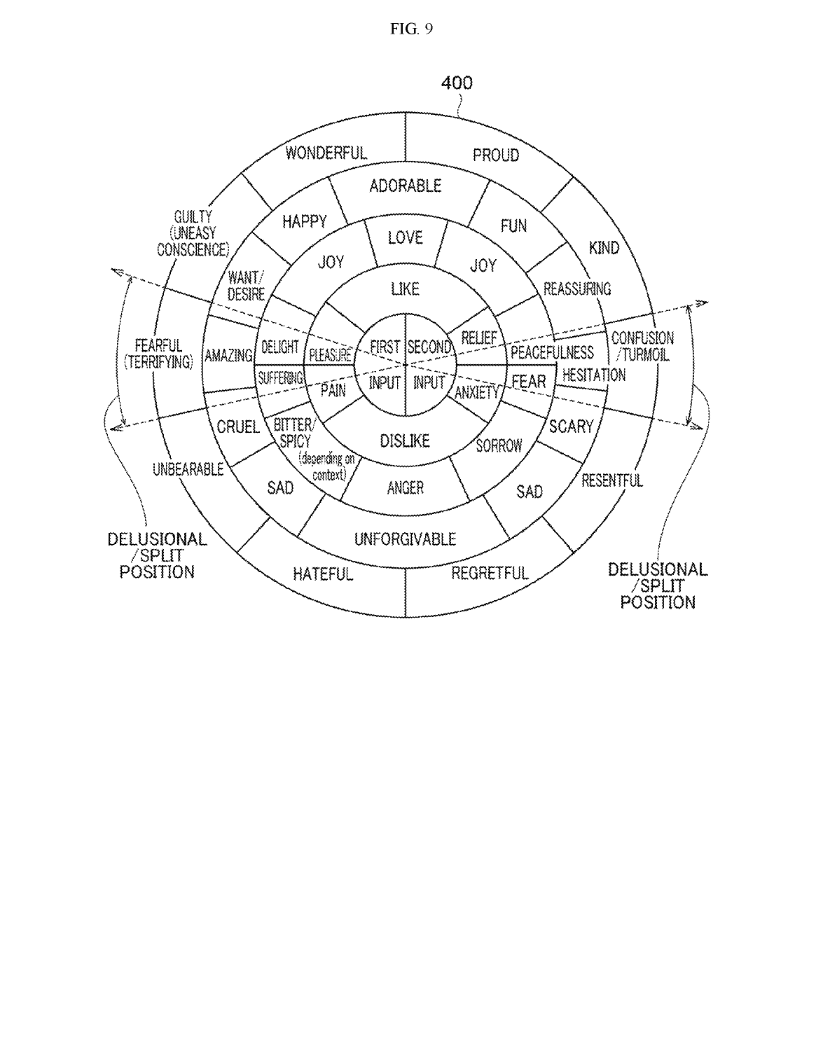

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

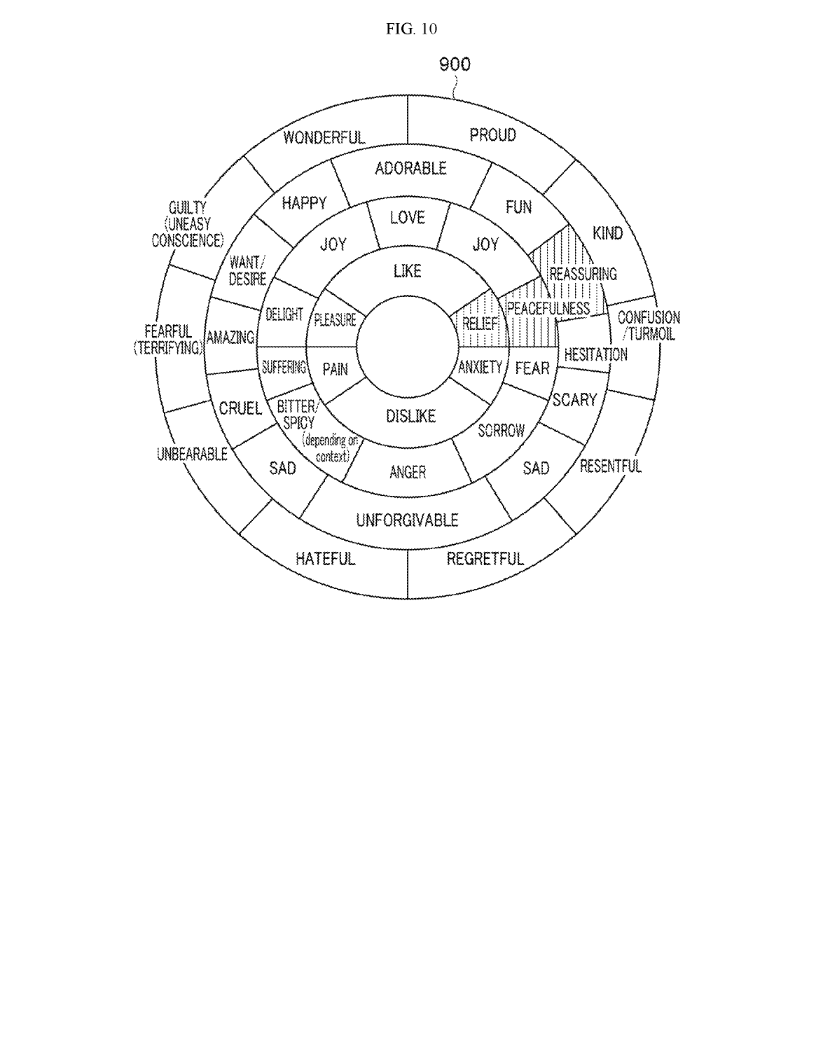

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

generate a learning model for identifying fraudulent activities based on past fraudulent activity cases;

convert audio information collected by an audio input device into character information by using audio recognition technology;

input the converted character information to the learning model and evaluate the possibility of fraudulent activities;

notify warning information from an information processing apparatus to a user apparatus when the possibility of fraudulent activities is evaluated;

generate and present guidance information displaying specific defensive actions to a user;

acquire and transmit partial character information sequentially, and perform the entire processing in real time;

generate warning information and guidance information by using a generative artificial intelligence model;

and generate an optimal prompt sentence for training or operation for fraudulent activity identification.

### Supplementary 2

The system according to supplementary 1,

wherein the processor is configured to extract features of fraudulent activities from character information by applying natural language processing technology in the learning model.

### Supplementary 3

The system according to supplementary 1,

wherein the processor is configured to monitor audio information intermittently or continuously during a call, and to perform immediate notification and display processing to the user apparatus based on the evaluation result.

### Application Example 1

### Supplementary 1

A system comprising a processor,

wherein the processor is configured to

generate and maintain an information processing model for identifying fraudulent activity based on previous fraud cases,

convert acoustic information acquired from a terminal device into character information,

input the character information to the information processing model and evaluate the likelihood of fraud,

provide a warning notification to a subject when a potential fraud is evaluated,

estimate the emotion of the subject through input or output sections of a terminal device,

automatically adjust the contents and format of the warning notification based on emotion estimation results,

present specific action guidelines to the subject for fraud prevention,

collect feedback information from the subject, and utilize the feedback to improve the accuracy of the information processing model and emotion estimation,

employ a generative artificial intelligence model as the information processing model, and input instruction sentences for fraud feature evaluation.

### Supplementary 2

The system according to supplementary 1,

wherein the processor is configured to extract fraud features using natural language processing technology and contribute to output and decision-making of warning notifications.

### Supplementary 3

The system according to supplementary 1,

wherein the processor is configured to monitor, in real time, acoustic information and emotion estimation data, and, upon detection of potential fraud or psychological stress during communication, immediately notify the subject with alerts and appropriate action guidelines.

### Example 2

### Supplementary 1

A system comprising a processor,

wherein the processor is configured to

generate a machine learning algorithm for identifying abnormal behavior based on past abnormal behavior cases,

convert acoustic information acquired from an information acquisition device into text information,

extract emotional state information from the acoustic information,

input the text information and the emotional state information into the machine learning algorithm to evaluate the possibility of abnormal behavior and the emotional state of a user,

generate alert information with controlled content and urgency based on the evaluation of the possibility of abnormal behavior and the user’s emotional state,

notify a user terminal of the alert information and cause the user terminal to inform the user using a voice output device and a display device,

present guidance information indicating responsive actions for the user in addition to the alert information,

and use a generative artificial intelligence model to generate the alert information and the guidance information, using a prompt sentence as input.

### Supplementary 2

The system according to supplementary 1,

wherein the processor is configured to

extract feature values of abnormal behavior and emotional tendency using natural language analysis technology in the machine learning algorithm.

### Supplementary 3

The system according to supplementary 1,

wherein the processor is configured to

monitor the acoustic information in real time and, when the possibility of abnormal behavior and a sudden change in emotional state are detected during a communication, immediately notify the user of the alert information and the guidance information.

### Application Example 2

### Supplementary 1

A system comprising a processor,

wherein the processor is configured to

convert audio information acquired from a communication terminal device into character information,

extract audio features from the audio information,

generate a machine learning apparatus for identifying fraudulent activity based on past fraudulent cases,

evaluate the possibility of fraudulent activity by inputting the character information into the machine learning apparatus,

estimate a user's emotional state by inputting the audio features into an emotion state analysis apparatus,

provide a user with warning information and countermeasure information based on results of both the fraudulent activity evaluation and the emotional state estimation,

adjust the content or display form of the warning and countermeasure information in accordance with the estimated emotional state,

and generate an instruction sentence for inputting structured information and analysis results to a generative artificial intelligence model, and provide the user with a warning message or the like obtained from the generative artificial intelligence model.

### Supplementary 2

The system according to supplementary 1,

wherein the processor is configured to

extract characteristics of fraudulent activity using natural language processing techniques in the machine learning apparatus.

### Supplementary 3

The system according to supplementary 1,

wherein the processor is configured to

monitor audio information from the communication terminal device in real time and notify the user immediately with warning and countermeasure information when there is a possibility of fraudulent activity during a call.

What is claimed is:

1. A system comprising a processor,
wherein the processor is configured to generate a machine learning model for identifying fraudulent activity based on past scam cases,
convert audio data from a communication device into text data,
input the converted text data into the machine learning model and evaluate the possibility of fraud,
notify the user with a warning if the possibility of fraud is evaluated, and
provide the user with specific countermeasures to protect themselves from fraud.

2. The system according to claim 1, wherein the processor is configured such that the machine learning model extracts characteristics of fraud using natural language processing technology.

3. The system according to claim 1, wherein the processor is configured to monitor the audio data in real time and immediately notify the user if there is a possibility of fraud during a call.
